(19) United States
(12) Patent Application Publication
(10) Pub. No.: US 2021/0191048 A1
(43) Pub. Date: Jun. 24, 2021

(54) OPTICAL MODULE

(71) Applicant: FUJITSU LIMITED, Kawasaki-shi (JP)

(72) Inventors: Takayoshi Matsumura, Yokohama (JP); NORIO KAINUMA, Nagano (JP); TAKASHI KUBOTA, Chikuma (JP)

(73) Assignee: FUJITSU LIMITED, Kawasaki-shi (JP)

(21) Appl. No.: 17/089,929

(22) Filed: Nov. 5, 2020

(30) Foreign Application Priority Data
Dec. 18, 2019 (JP) 2019-228686

(51) Int. Cl. G02B 6/36; G02B 6/38; G02B 6/42

(52) U.S. Cl. CPC G02B 6/3644; G02B 6/4244; G02B 6/4239; G02B 6/3847

(57) ABSTRACT

An optical module includes a substrate in which a through hole or a recess is formed; a first component that is arranged in the through hole or the recess of the substrate, and is bonded to an inner wall surface of the through hole or the recess by a thermosetting adhesive in a portion of a gap between the first component and the inner wall surface of the through hole or the recess; and a second component that is connected to an electrode on one surface of the first component and an electrode on one surface of the substrate, across the gap between the first component and the inner wall surface of the through hole or the recess.

### CROSS-REFERENCE TO RELATED APPLICATION

This application is based upon and claims the benefit of priority of the prior Japanese Patent Application No. 2019-228686, filed on Dec. 18, 2019, the entire contents of which are incorporated herein by reference.

### FIELD

The embodiments discussed herein are related to an optical module.

### BACKGROUND

In recent years, with miniaturization and speeding up of optical modules that perform predetermined optical processes, attention has been focused on high-density component mounting on a substrate in an optical module. As such an optical module, for example, there is one that uses bridge mounting for mounting components as a bridge type.

In an optical module using the bridge mounting, for example, an optical component that performs a predetermined optical process according to an electrical signal is arranged in a recess formed in a substrate, and an electrical component that supplies an electrical signal to the optical component is connected in a bridge form across the optical component and the substrate. For example, the electrical component is connected to an electrode on the optical component and an electrode on the substrate across a gap between the optical component and an inner wall surface of the recess of the substrate.

The optical component is bonded to the inner wall surface of the recess of the substrate with, for example, a thermosetting adhesive in the entire gap between the optical component and the inner wall surface of the recess of the substrate. For example, the entire gap between the optical component and the inner wall surface of the recess of the substrate is filled with an uncured adhesive. Then, by thermally curing the uncured adhesive, the optical component arranged in the recess of the substrate is bonded to the inner wall surface of the recess of the substrate. For example, Japanese Laid-open Patent Publication No. 2004-216649 and the like are disclosed as related art.

### SUMMARY

According to an aspect of the embodiments, an optical module includes a substrate in which a through hole or a recess is formed; a first component that is arranged in the through hole or the recess of the substrate, and is bonded to an inner wall surface of the through hole or the recess by a thermosetting adhesive in a portion of a gap between the first component and the inner wall surface of the through hole or the recess; and a second component that is connected to an electrode on one surface of the first component and an electrode on one surface of the substrate, across the gap between the first component and the inner wall surface of the through hole or the recess.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a cross-sectional side view illustrating a configuration of an optical module according to an embodiment;

FIG. 2 is a diagram illustrating an example of a bonding portion between an optical component and an inner wall surface of a through hole;

FIG. 3 is a cross-sectional side view illustrating a configuration of an optical module according to a comparative example;

FIGS. 4A to 4C are diagrams for explaining a flow of a method for manufacturing the optical module according to the present embodiment;

FIG. 5 is a diagram illustrating modification example 1 of a bonding region of the optical component with an adhesive;

FIG. 6 is a diagram illustrating modification example 2 of the bonding region of the optical component with the adhesive;

FIG. 7 is a diagram illustrating modification example 3 of the bonding region of the optical component with the adhesive;

FIG. 8 is a diagram illustrating modification example 4 of the bonding region of the optical component with the adhesive;

FIG. 9 is a diagram illustrating modification example 5 of the bonding region of the optical component with the adhesive;

FIG. 10 is a diagram illustrating modification example 6 of the bonding region of the optical component with the adhesive;

FIG. 11 is a diagram illustrating modification example 7 of the bonding region of the optical component with the adhesive;

FIG. 12 is a diagram illustrating an example of results of simulating stress on connecting portions of an electrical component to electrodes on a substrate;

FIG. 13 is a diagram illustrating an example of results of simulating stress on the connecting portions of the electrical component to the electrodes on the substrate; and

FIG. 14 is a diagram illustrating an example of results of simulating stress on the connecting portions of the electrical component to the electrodes on the substrate.

### DESCRIPTION OF EMBODIMENTS

Incidentally, when the adhesive filled in the entire gap between the optical component and the inner wall surface of the recess of the substrate is thermally cured, thermal expansion and thermal contraction of the substrate are caused simultaneously, and thereby stress is applied to the entire circumference of the optical component from the entire inner wall surface of the recess of the substrate via the adhesive. When the stress is applied to the entire circumference of the optical component from the entire inner wall surface of the recess of the substrate via the adhesive, while the optical component is pulled upward by the electrical component connected in the bridge form to the electrode on the optical component and the electrode on the substrate, the substrate is pulled upward near the recess, consequently, there is a problem that the stress concentrates on connecting portions of the electrical component to the electrode on the optical component and the electrode on the substrate, and the component is damaged or peeled off at these connecting portions.

In view of the above, it is desirable to suppress damage or peeling of the component connected in the bridge form.

Hereinafter, an embodiment of an optical module disclosed in the present application will be described in detail with reference to the drawings. Note that this embodiment does not limit the disclosed technology.

### EMBODIMENT

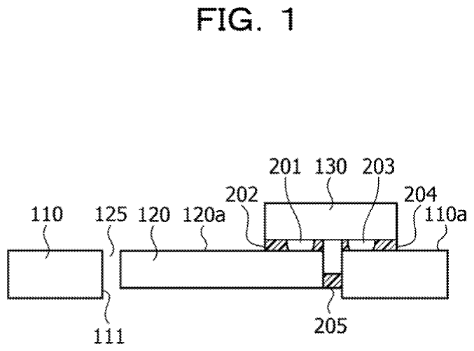

FIG. 1 is a cross-sectional side view illustrating a configuration of an optical module 100 according to the embodiment. Hereinafter, for convenience of description, a surface on an upper side of the paper surface of FIG. 1 is referred to as an upper surface, and a surface on a lower side of the paper surface is referred to as a lower surface. However, the optical module 100 may be used upside down, for example, and may be used in any posture. The optical module 100 illustrated in FIG. 1 has a substrate 110, an optical component 120, and an electrical component 130.

The substrate 110 is, for example, a glass epoxy substrate, and is a component on which various components forming the optical module are mounted. Electrodes for electrically connecting various components are formed on an upper surface 110a of the substrate 110. Further, in the substrate 110, a substantially rectangular through hole 111 arranging the optical component 120 is formed.

The optical component 120 is a chip component that has an optical waveguide and an electrode on an upper surface 120a, propagates light from a light source through the optical waveguide, and performs optical modulation based on an electrical signal supplied to the electrode. The optical component 120 performs optical modulation based on, for example, an electrical signal supplied from the electrical component 130 to the electrode.

Further, the optical component 120 is arranged in the through hole 111 of the substrate 110. For example, by connecting the electrode on the upper surface 120a of the optical component 120 to a lower surface of the electrical component 130, the optical component 120 is arranged in the through hole 111 in a state that the gap 125 is formed between the optical component 120 and an inner wall surface of the through hole 111.

The optical component 120 is bonded to the inner wall surface of the through hole 111 with a thermosetting adhesive 205 in a portion of the gap 125 between the optical component 120 and the inner wall surface of the through hole 111. For example, the optical component 120 is partially bonded to the inner wall surface of the through hole 111 by the adhesive 205 in a state that a portion not filled with the adhesive 205 remains in the gap 125 between the optical component 120 and the inner wall surface of the through hole 111. A region where the optical component 120 is bonded to the inner wall surface of the through hole 111 by the adhesive 205 will be described later. The optical component 120 is an example of a first component.

The electrical component 130 is, for example, a chip component such as a driver that supplies an electrical signal to the optical component 120, and is connected in a bridge form across the optical component 120 and the substrate 110. For example, the electrical component 130 is connected to the electrode on the upper surface 120a of the optical component 120 and an electrode on the upper surface 110a of the substrate 110 across the gap 125 between the optical component 120 and the inner wall surface of the through hole 111. The connection of the electrical component 130 to the electrode on the upper surface 120a of the optical component 120 is achieved by, for example, flip-chip connecting the electrical component 130 to the electrode on the upper surface 120a by a solder ball 201, and filling an adhesive 202 between the electrical component 130 and the optical component 120. The connection of the electrical component 130 to the electrode on the upper surface 110a of the substrate 110 is achieved by, for example, flip-chip connecting the electrical component 130 to the electrode on the upper surface 110a by a solder ball 203, and filling an adhesive 204 between the electrical component 130 and the substrate 110. The electrical component 130 is an example of a second component.

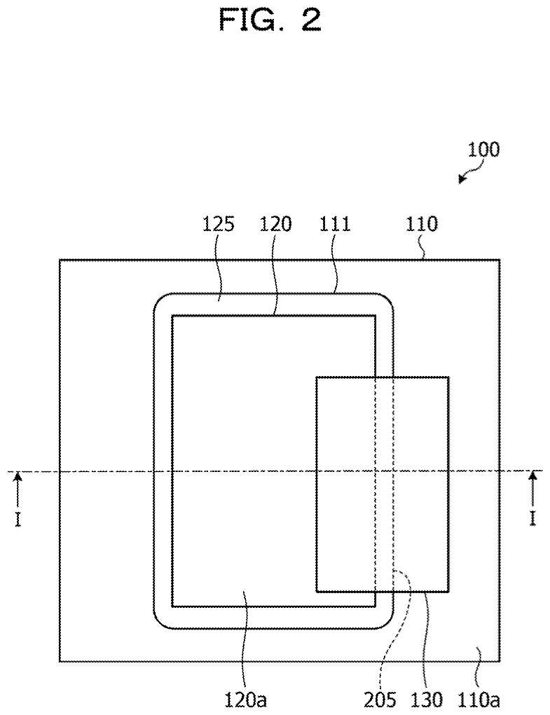

Here, the bonding portion between the optical component 120 and the inner wall surface of the through hole 111 will be described with reference to FIG. 2. FIG. 2 is a diagram illustrating an example of a bonding portion between the optical component 120 and the inner wall surface of the through hole 111. In FIG. 2, a plan view of the optical module 100 as viewed from above is schematically illustrated. A cross-sectional view taken along a line I-I of FIG. 2 corresponds to FIG. 1.

As illustrated in FIG. 2, the substrate 110, the optical component 120, and the gap 125 between the optical component 120 and the inner wall surface of the through hole 111 partially overlap with the electrical component 130 when viewed from a direction perpendicular to the upper surface 120a of the optical component 120. Then, as described above, the optical component 120 is bonded to the inner wall surface of the through hole 111 by the thermosetting adhesive 205 in a portion of the gap 125. For example, the optical component 120 is bonded by the adhesive 205 in a portion of the gap 125, the portion overlapping with the electrical component 130 when viewed from the direction perpendicular to the upper surface 120a of the optical component 120.

By bonding the optical component 120 to the inner wall surface of the through hole 111 by the adhesive 205 in a portion of the gap 125, a portion remains where the gap 125 is not filled with the adhesive 205. Thus, even if thermal expansion and thermal contraction of the substrate 110 are caused when the adhesive 205 filled in the gap 125 is thermally cured, no stress is applied from the inner wall surface of the through hole 111 of the substrate 110 to the entire circumference of the optical component 120 via the adhesive 205. Therefore, even if the optical component 120 is pulled upward by the electrical component 130 and the substrate 110 is pulled upward near the through hole 111, concentration of stress on the connecting portions of the electrical component 130 to the electrode on the optical component 120 and the electrode on the substrate 110 is reduced. Consequently, damage or peeling of the electrical component 130 may be suppressed.

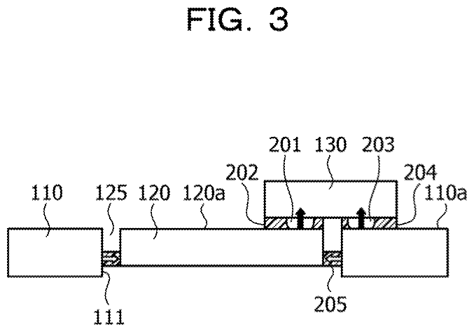

FIG. 3 is a cross-sectional side view illustrating a configuration of are optical module according to a comparative example. As illustrated in FIG. 3, in the optical module according to the comparative example, the optical component 120 is bonded to the inner wall surface of the through hole 111 of the substrate 110 with the thermosetting adhesive 205 in the entire gap 125. In the optical module according to the comparative example, when the adhesive 205 is thermally cured, thermal expansion and thermal contraction of the substrate 110 are caused simultaneously, thereby applying stress from the entire inner wall surface of the through hole 111 of the substrate 110 to the entire circumference of the optical component 120 via the adhesive 205. In FIG. 3, the stress applied to the entire circumference of the optical component 120 is indicated by white arrows. When the stress is applied to the entire circumference of the optical component 120, the optical component 120 is pulled upward by the electrical component 130 connected to the electrode on the optical component 120 and the electrode on the substrate 110 in a bridge form, and the substrate 110 is pulled upward near the through hole 111. In FIG. 3, directions in which the optical component 120 and the substrate 110 are pulled are indicated by black arrows. By application of the stress to the entire circumference of the optical component 120 and pulling of the optical component 120 and the substrate 110 upward, stress concentrates on each of the connecting portions of the electrical component 130 to the electrode of the optical component 120 and the electrode on the substrate 110. Consequently, damage or peeling of the electrical component 130 occurs at these connecting portions. For example, cracks may occur around the solder balls 201, 203 on the lower surface of the electrical component 130, or the electrical component 130 may peel off from the adhesives 202, 204.

On the other hand, in the optical module 100 according to the present embodiment, as illustrated in FIGS. 1 and 2, the optical component 120 is bonded to the inner wall surface of the through hole 111 of the substrate 110 with the thermosetting adhesive 205 in a portion of the gap 125. For example, in the optical module 100, the optical component 120 is bonded to the inner wall surface of the through hole 111 of the substrate 110 by the adhesive 205 in a portion of the gap 125, the portion overlapping with the electrical component 130 when viewed from the direction perpendicular to the upper surface 120a of the optical component 120. Thus, in a portion of the gap 125 that does not overlap with the electrical component 130 when viewed from the direction perpendicular to the upper surface 120a of the optical component 120, the inner wall surface of the through hole 111 of the substrate 110 and the optical component 120 do not come into direct contact with each other, and thus the stress is not applied to the entire circumference of the optical component 120. Consequently, concentration of stress on the connecting portions of the electrical component 130 to the electrode on the optical component 120 and the electrode on the substrate 110 is reduced, and thus damage or peeling of the electrical component 130 may be suppressed.

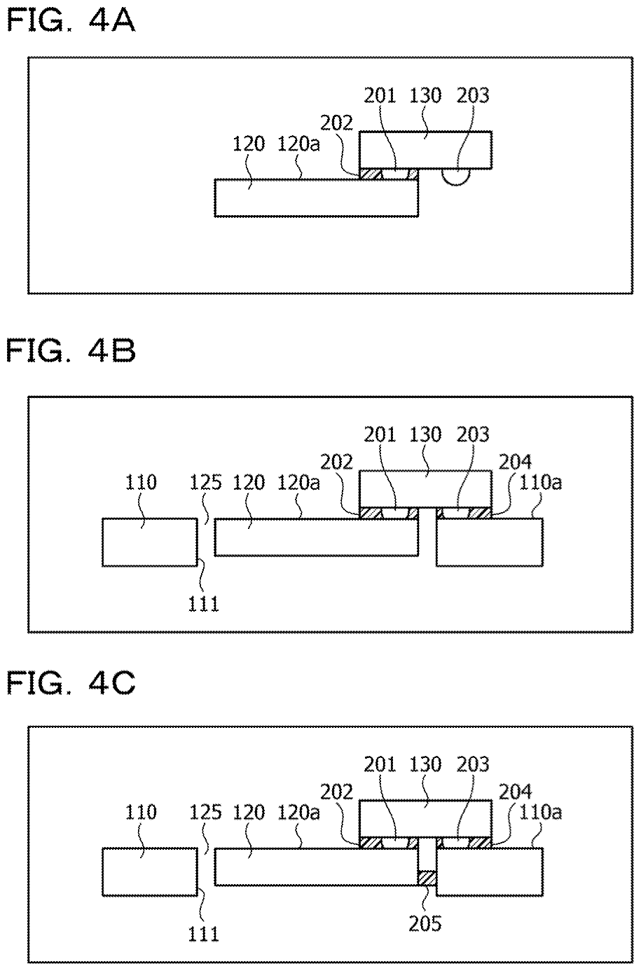

Next, a method for manufacturing the optical module 100 according to the present embodiment will be described with reference to FIGS. 4A to 4C. FIGS. 4A to 4C are diagrams for explaining a flow of the method for manufacturing the optical module 100 according to the present embodiment.

As illustrated in FIG. 4A, first, the electrical component 130 is connected to the electrode on the upper surface 120a of the optical component 120. For example, the electrical component 130 is flip-chip connected to the electrode on the upper surface 120a of the optical component 120 by the solder ball 201, and the adhesive 202 is filled between the electrical component 130 and the optical component 120. At this time, the solder ball 203 is installed on the lower surface of the electrical component 130 as needed. Once the adhesive 202 is filled between the electrical component 130 and the optical component 120, the adhesive 202 is thermally cured.

Subsequently, as illustrated in FIG. 4B, with the optical component 120 arranged in the through hole 111 formed in the substrate 110, the electrical component 130 is connected to the electrode on the upper surface 110a of the substrate 110 across the gap 125 between the optical component 120 and the inner wall surface of the through hole 111. For example, the electrical component 130 is flip-chip connected to the electrode on the upper surface 110a of the substrate 110 by the solder ball 203, and the adhesive 204 is filled between the electrical component 130 and the substrate 110. Once the adhesive 204 is filled between the electrical component 130 and the substrate 110, the adhesive 204 is thermally cured. Note that the adhesive 204 may have the same or different thermosetting temperature as the adhesive 202.

Subsequently, as illustrated in FIG. 4C, a portion of the gap 125 between the optical component 120 and the inner wall surface of the through hole 111 is filled with the adhesive 205. For example, the adhesive 205 is filled in a portion of the gap 125, the portion overlapping with the electrical component 130 when viewed from the direction perpendicular to the upper surface 120a of the optical component 120. Once the adhesive 205 is filled in the portion of the gap 125, the adhesive 205 is thermally cured. At this time, even if thermal expansion and thermal contraction of the substrate 110 are caused, stress is only applied to a portion of the entire circumference of the optical component 120 from the inner wall surface of the through hole 111 of the substrate 110 via the adhesive 205. Therefore, even if the optical component 120 is pulled upward by the electrical component 130 and the substrate 110 is pulled upward near the through hole 111, concentration of stress on the connecting portions of the electrical component 130 to the electrode on the optical component 120 and the electrode on the substrate 110 is reduced. Consequently, damage or peeling of the electrical component 130 may be suppressed. Note that the adhesive 205 may have the same or different thermosetting temperature as the adhesives 202, 204. When the thermosetting temperature differs between the adhesive 205 and the adhesives 202, 204, it is preferable that the adhesive 205 has a lower thermosetting temperature than the adhesives 202, 204. Thus, thermal expansion and thermal contraction of the substrate is suppressed when the adhesive 205 is thermally cured.

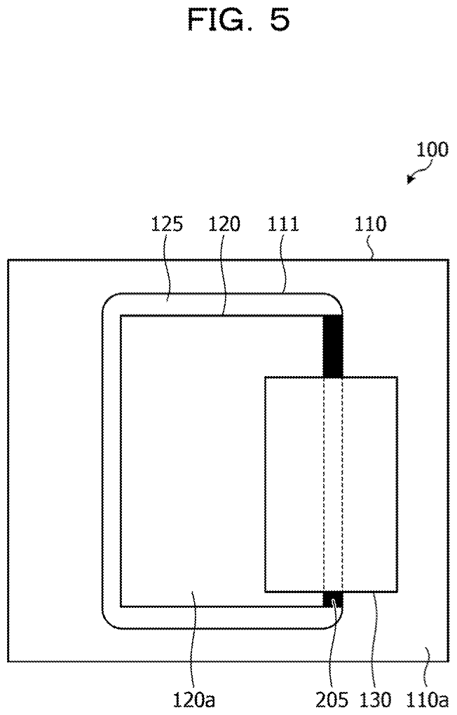

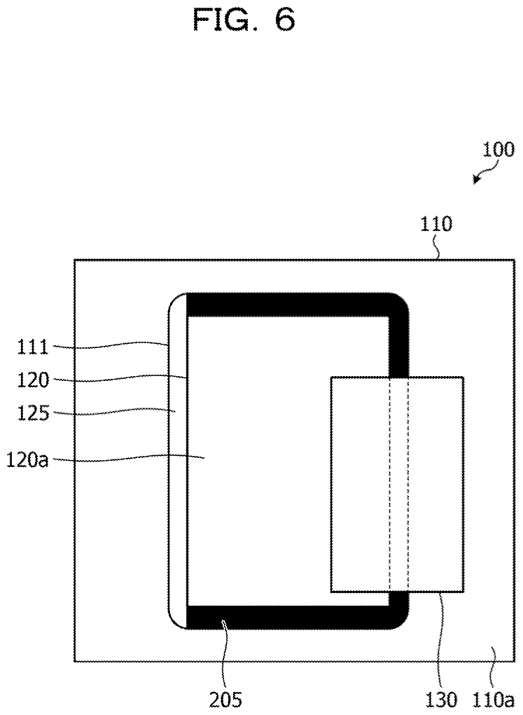

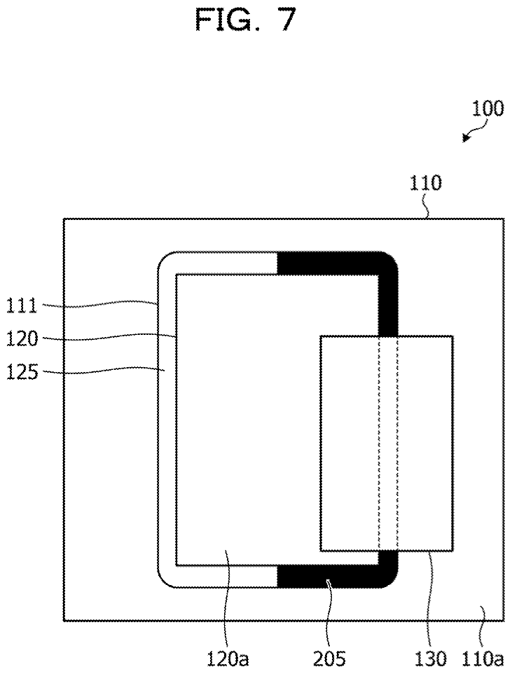

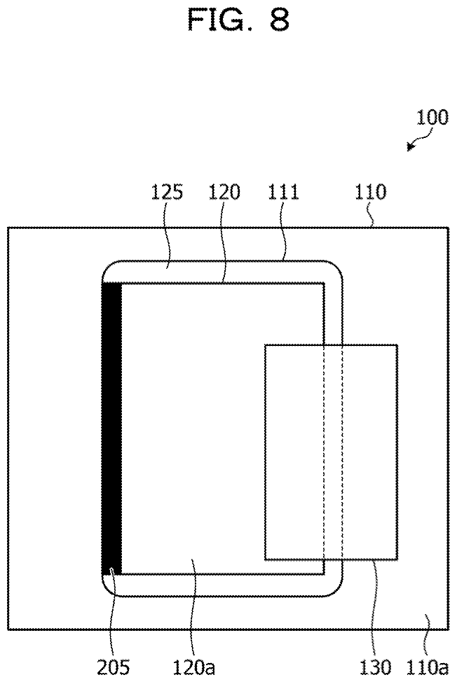

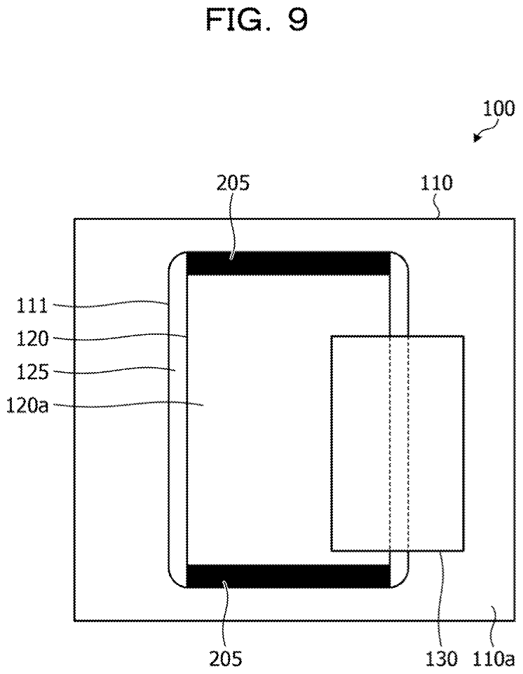

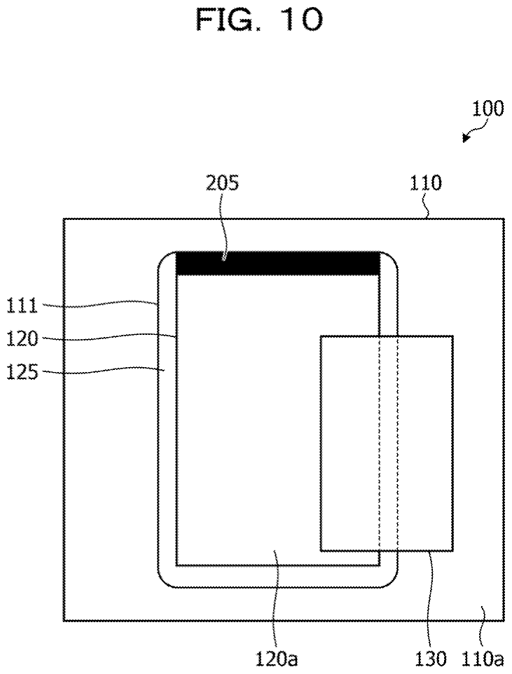

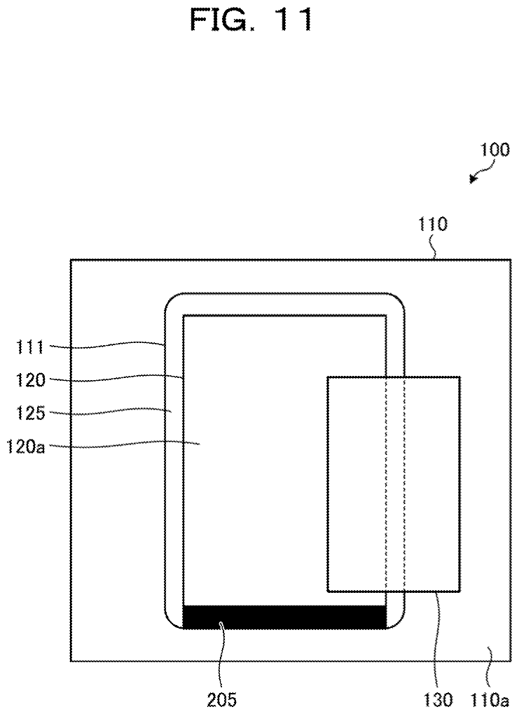

Note that in the embodiment described above, the case where the optical component 120 is bonded by the adhesive 205 in the portion of the gap 125, the portion overlapping with the electrical component 130 when viewed from the direction perpendicular to the upper surface 120a of the optical component 120, has been illustrated, but the optical component may be bonded in another portion. For example, as illustrated in FIG. 5, the optical component 120 may be bonded by the adhesive 205 in a portion of the gap 125, the portion being along one side of the upper surface 120a, the one side overlapping with the electrical component 130 when viewed from the direction perpendicular to the upper surface 120a of the optical component 120. Further, for example, as illustrated in FIG. 6, the optical component 120 may be bonded by the adhesive 205 in a portion of the gap 125, the portion being along one side of the upper surface 120a and two sides continuous to the one side, the one side overlapping with the electrical component 130 when viewed from the direction perpendicular to the upper surface 120a of the optical component 120. Further, for example, as illustrated in FIG. 7, the optical component 120 may be bonded by the adhesive 205 in a portion of the gap 125, the portion being along one side of the upper surface 120a and halves of two sides continuous to the one side, the one side overlapping with the electrical component 130 when viewed from the direction perpendicular to the upper surface 120a of the optical component 120. Further, for example, as illustrated in FIG. 8, the optical component 120 may be bonded by the adhesive 205 in a portion of the gap 125, the portion being along one side of the upper surface 120a, the one side not overlapping with the electrical component 130 when viewed from the direction perpendicular to the upper surface 120a of the optical component 120. Further, for example, as illustrated in FIG. 9, the optical component 120 may be bonded by the adhesive 205 in portions of the gap 125, the portions being along both two sides that are continuous to one side of the upper surface 120a, the one side overlapping with the electrical component 130 when viewed from the direction perpendicular to the upper surface 120a of the optical component 120. Further, for example, as illustrated in FIGS. 10 and 11, the optical component 120 may be bonded by the adhesive 205 in a portion of the gap 125, the portion being along one of two sides that are continuous to one side of the upper surface 120a, the one side overlapping with the electrical component 130 when viewed from the direction perpendicular to the upper surface 120a of the optical component 120. FIGS. 5 to 11 are views illustrating modification examples 1 to 7, respectively, of the bonding portion of the optical component 120 with the adhesive 205. In any of the cases illustrated in FIGS. 5 to 11, the optical component 120 is bonded to the inner wall surface of the through hole 111 by the adhesive 205 in a portion of the gap 125. Then, in any of the cases illustrated in FIGS. 5 to 11, concentration of stress on the connecting portions of the electrical component 130 to the electrode on the optical component 120 and the electrode on the substrate 110 is reduced, and thus damage or peeling to the electrical component 130 may be suppressed.

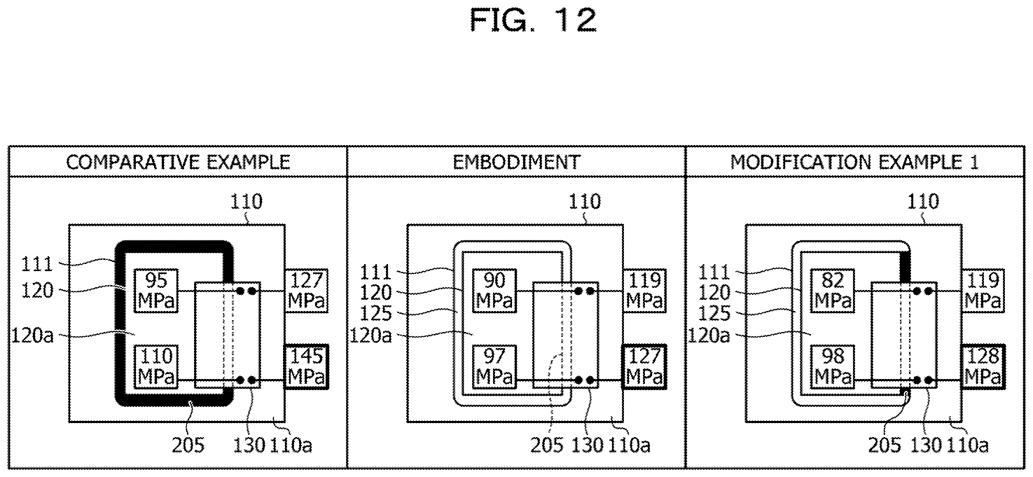

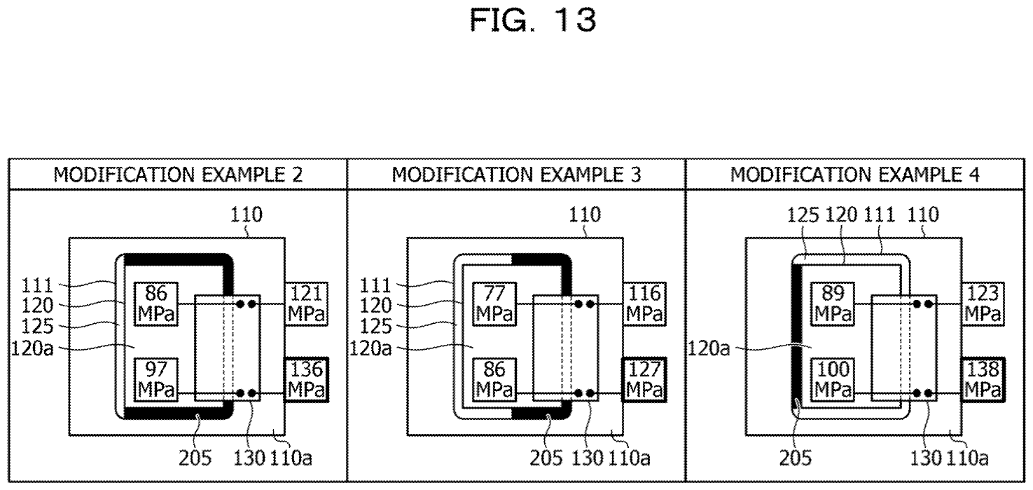

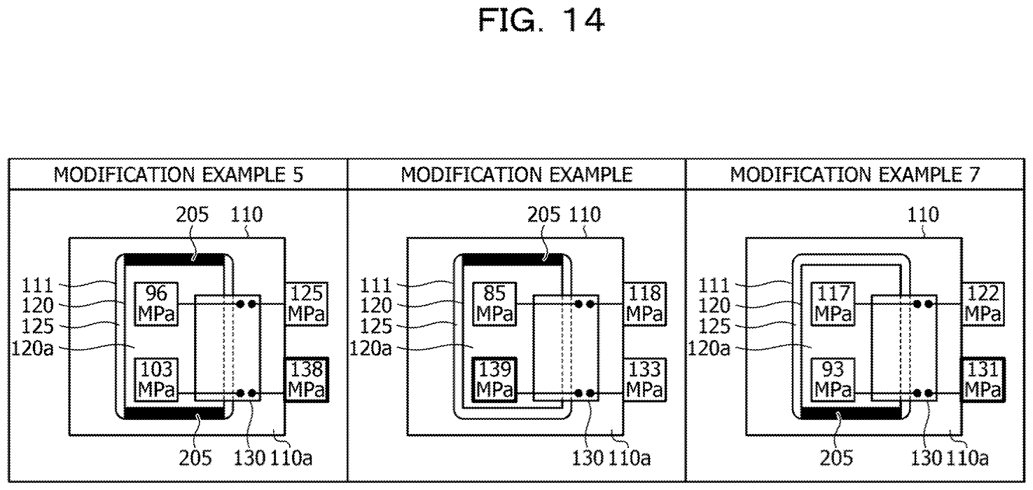

FIGS. 12 to 14 are diagrams illustrating an example of a result of simulating stress on connecting portions of the electrical component 130 to electrodes on the substrate 110. FIG. 12 illustrates, as a comparative example, the stress applied to the connecting portions when the optical component 120 is bonded to the entire gap 125 by the adhesive 205. Further, FIGS. 12 to 14 illustrate stress on the connecting portions when the optical component 120 is bonded by the adhesive 205 in the portions illustrated in FIGS. 5 to 11 in the gap 125 as modification examples 1 to 7.

As illustrated in FIGS. 12 to 14, in the comparative example in which the optical component 120 is bonded in the entire gap 125, the maximum value of the stress on the connecting portions of the electrical component 130 to the electrodes on the substrate 110 is 145 MPa. On the other hand, in the embodiment and the modification examples 1 to 7 in which the optical component 120 is bonded in the portion of the gap 125, the maximum value of the stress on the connecting portions of the electrical component 130 to the electrodes on the substrate 110 is a value smaller than 145 MPa. For example, in the embodiment and the modification examples 1 to 7, it is possible to reduce the concentration of stress on the connecting portions of the electrical component 130 to the electrodes on the substrate 110, as compared with the comparative examples. Thus, in the embodiment and the modification examples 1 to 7, it is possible to suppress damage or peeling of the electrical component 130.

As described above, the optical module 100 according to the embodiment includes the substrate 110, the optical component 120, and the electrical component 130. The through hole 111 is formed in the substrate 110. The optical component 120 is arranged in the through hole 111 of the substrate 110, and is bonded to the inner wall surface of the through hole 111 by the thermosetting adhesive 205 in the portion of the gap 125 between the optical component 120 and the inner wall surface of the through hole 111, The electrical component 130 is connected to the electrode on the upper surface 120a of the optical component 120 and the electrode on the upper surface 110a of the substrate 110 across the gap 125 between the optical component 120 and the inner wall surface of the through hole 111. Thus, the optical module 100 may suppress damage or peeling of the electrical components 130 connected in the bridge form.

Note that in the embodiment described above, the case where the optical component 120 is arranged in the through hole 111 formed in the substrate 110 has been illustrated, but the optical component 120 may be arranged in a recess formed in the substrate 110. For example, the optical component 120 arranged in the recess of the substrate 110 may be bonded to the inner wall surface of the recess by a thermosetting adhesive in a portion of a gap between the optical component 120 and the inner wall surface of the recess. Even when the optical component 120 is arranged in the recess, concentration of stress on the connecting portion of the electrical component 130 to the electrode on the optical component 120 and the electrode on the substrate 110 is reduced, and thus damaging or peeling of the electrical component 130 may be suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical module comprising:
a substrate in which a through hole or a recess is formed;
a first component that is arranged in the through hole or the recess of the substrate, and is bonded to an inner wall surface of the through hole or the recess by a thermosetting adhesive in a portion of a gap between the first component and the inner wall surface of the through hole or the recess; and
a second component that is connected to an electrode on one surface of the first component and an electrode on one surface of the substrate, across the gap between the first component and the inner wall surface of the through hole or the recess.

2. The optical module according to claim 1, wherein
the first component is bonded by the adhesive in a portion of the gap, the portion overlapping with the second component when viewed from a direction perpendicular to the one surface of the first component.

3. The optical module according to claim 1, wherein
the first component is bonded by the adhesive in a portion of the gap, the portion being along one side of the one surface, the one side overlapping with the second component when viewed from a direction perpendicular to the one surface of the first component.

4. The optical module according to claim 1, wherein
the first component is bonded by the adhesive in a portion of the gap, the portion being along one side of the one surface and two sides continuous to the one side, the one side overlapping with the second component when viewed from a direction perpendicular to the one surface of the first component.

5. The optical module according to claim 1, wherein
the first component is bonded by the adhesive in a portion of the gap, the portion being along one side of the one surface, the one side not overlapping with the second component when viewed from a direction perpendicular to the one surface of the first component.

6. The optical module according to claim 1, wherein
the first component is bonded by the adhesive in a portion of the gap, the portion being along at least one of two sides that are continuous to one side of the one surface, the one side overlapping with the second component when viewed from a direction perpendicular to the one surface of the first component.
